(19) United States
(12) Patent Application Publication
(10) Pub. No.: US 2015/0170439 A1
(43) Pub. Date: Jun. 18, 2015

(54) AUTOMOTIVE FLEET MANAGEMENT SYSTEM HAVING AN AUTOMATED VEHICLE MAINTENANCE AND REPAIR REFERRAL

(71) Applicant: Innova Electronics, Inc., Irvine, CA (US)

(72) Inventors: leon C. Chen, Laguna Hills, CA (US); Michael Fitzgerald, Madison, CT (US); Doug Sobieski, North Salt Lake, UT (US)

(21) Appl. No.: 14/634,138

(22) Filed: Feb. 27, 2015

Related U.S. Application Data
(63) Continuation-in-part of application No. 12/768,630, filed on Apr. 27, 2010.
(60) Provisional application No. 61/954,432, filed on Mar. 17, 2014.

(51) Int. Cl. G07C 5/00

(52) U.S. Cl. CPC G07C 5/008

(57) ABSTRACT

An automotive diagnostic method including the step of providing an automotive data retrieving tool having a unique tool identifier, wherein the automotive data retrieving tool is configured to retrieve data from a vehicle onboard computer. Information related to a selling retailer associated with the automotive data retrieving tool is received and the unique tool identifier is associated with the selling retailer in a referral server. The method further includes receiving vehicle data from the automotive data retrieving tool, and analyzing the received vehicle data to make a diagnostic assessment, which is communicated along with the unique tool identifier to the referral server. The method additionally includes the step of matching the unique tool identifier communicated with the diagnostic assessment with the associated selling retailer and generating a referral signal including information related to a possible commercial transaction conducted by the selling retailer.

### CROSS-REFERENCE TO RELATED APPLICATIONS

This application claims priority to U.S. Provisional Patent Application No. 61/954,432, filed on Mar. 17, 2014, and is a continuation-in-part of U.S. application Ser. No. 12/768,630, filed Apr. 27, 2010, the contents of both applications being expressly incorporated herein by reference.

### STATEMENT RE: FEDERALLY SPONSORED RESEARCH/DEVELOPMENT

Not Applicable

### BACKGROUND

1. Technical Field of the Invention

The present invention generally relates to a cooperative arrangement between a manufacturer or diagnostic service provider and a retailer, and more specifically to a system wherein a selling retailer sells the manufacturer's tool, which provides a subsequent referral back to the selling retailer during use of the tool by an end user.

2. Description of the Related Art

During the life of a typical vehicle, the need for routine maintenance and repair typically arises several times. Moreover, accidents may occur which may create the need for repairs in addition to the regularly scheduled maintenance of the vehicle. Accordingly, the automotive maintenance and repair industry is very large and comprises a wide range of companies which offer competitive parts and services.

Many vehicles are equipped with systems and sensors which help the vehicle owner anticipate and identify needed repairs. In this regard, most modern vehicles are equipped with an onboard electronic unit (ECU) which is in communication with several systems and sensors located on the vehicle, which allows the ECU to collect data during the operation of the vehicle. A review of such operational data may prove to be useful in determining whether diagnostic repairs are needed.

Many companies that interface with vehicle owners on an “after-market” basis for performing the needed repairs oftentimes have not ventured into manufacturing a tool designed to interface with the vehicle ECU for retrieving the operational data Likewise, a manufacturer of such a tool typically does not have the interaction and relationship with vehicle owners for facilitating sales of the tool.

Therefore, there is a need in the art for creating a relationship between a tool manufacturer and an after-market provider of repair parts and services to maximize their complimentary resources for creating a beneficial relationship between the companies and to provide an efficient customer experience for the end user. Various aspects of the present invention are directed toward addressing this need, as will be described in more detail below.

### BRIEF SUMMARY

Various aspects of the present invention are directed toward a system which creates a mutually-beneficial relationship between a tool manufacturer or diagnostic services provide and a parts and services retailer. The system is based around a data retrieving tool manufactured by the manufacturer and sold by the retailer. The data retrieving tool retrieves vehicle operational data from a vehicle, wherein the operational data may be reviewed and analyzed to determine whether repair parts or services are needed. When the need for such parts and services arise, the system notifies the retailer of the needed parts and services, and therefore, places the retailer in a preferred position relative to other competing retailers.

In this respect, the manufacturer benefits from the system because its data retrieving tool is sold by the retailer using existing marketing and distribution resources currently employed by the retailer. This may create a “link” or relationship between the manufacturer and the retailer. Furthermore, the retailer benefits by receiving “referrals” or information derived from the data retrieving tool regarding the status or health of the vehicle, and therefore, the retailer stands to benefit by selling repair parts or services.

According to one embodiment, there is provided an automotive diagnostic method including the step of providing an automotive data retrieving tool having a unique tool identifier. The automotive data retrieving tool is configured to retrieve data from a vehicle onboard computer. The unique tool identifier is associated with a selling retailer and contact information of an end user of the tool. The method further includes receiving, at a diagnostic server, vehicle data and the unique tool identifier from the automotive data retrieving tool. The received vehicle data is analyzed at the diagnostic server to make a diagnostic assessment. The method further includes sending a referral signal to the selling retailer associated with the automotive data retrieving tool based on the received unique tool identifier, wherein the referral signal includes the diagnostic assessment and the contact information of the end user of the tool.

The referral signal may include information regarding a replacement part associated with the diagnostic assessment and offered for sale by the selling retailer. The referral signal may also include information regarding a repair service associated with the diagnostic assessment and offered for sale by the selling retailer.

The method may include associating the selling retailer with the unique tool identifier after the selling retailer sells the automotive data retrieving tool to the end user. Alternatively, the method may include associating the selling retailer with the unique tool identifier before the selling retailer sells the automotive data retrieving tool to the end user.

The method may additionally include the step of communicating the referral signal to an end user of the automotive data retrieving tool.

The diagnostic assessment may be associated with a repair part, and the method may further include the step of searching an electronic parts database associated with the selling retailer for the repair part. The repair part may be associated with a universal part number associated with vehicle identification information, and the method may further include the step of receiving vehicle identification information. The universal part number may be an Aftermarket Catalog Enhanced Standard (ACES) part number.

The diagnostic assessment may include a predictive assessment of future diagnostic conditions.

According to another embodiment, there is provided an automotive diagnostic system including an automotive data retrieving tool configured to retrieve data from an onboard vehicle computer. The automotive data retrieving tool includes a unique tool identifier associated with a selling retailer and an end user contact information. A diagnostic and referral server is in communication with the automotive data retrieving tool, the diagnostic and referral server is configured to receive the retrieved data from the automotive data retrieving tool and analyze the retrieved data to make a diagnostic assessment and to send a referral signal to the selling retailer. The referral signal includes information related to the diagnostic assessment and the end user contact information.

The repair server may be configured to coordinate the sale of a repair part associated with the diagnostic assessment and offered for sale by the prescribed selling retailer. The repair server may be configured to coordinate a repair service associated with the diagnostic assessment and offered for sale by the prescribed selling retailer.

The automotive diagnostic system may additionally include a tool-retailer assignment module configured to assign the data retrieving tool with the prescribed selling retailer based on information related to a sale of the data retrieving tool.

The diagnostic and referral server may be configured to conduct a predictive assessment of future diagnostic conditions based on the retrieved data.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a schematic diagram of a system overview of one embodiment of an automotive diagnostic system constructed in accordance with an embodiment of the present invention;

FIG. 2 is a schematic diagram of a system overview of a second aspect of the automotive diagnostic system;

FIG. 3 is a schematic view of an embodiment of an automotive data retrieving tool;

FIG. 4 is a flow chart illustrating the process of selling an automotive data retrieving tool;

FIG. 5 is a flow chart illustrating the process of collecting data and generating referrals for a retailer; and

FIG. 6 is a flow chart illustrating an exemplary diagnostic method according to an aspect of the present invention.

### DETAILED DESCRIPTION

The detailed description set forth below in connection with the appended drawings is intended as a description of certain embodiments of an automotive vehicle maintenance and repair system, and a related method, and is not intended to represent the only forms that may be developed or utilized. The description sets forth the various structure and/or functions in connection with the illustrated embodiments, but it is to be understood, however, that the same or equivalent structure and/or functions may be accomplished by different embodiments that are also intended to be encompassed within the scope of the present disclosure. It is further understood that the use of relational terms such as first and second, and the like are used solely to distinguish one entity from another without necessarily requiring or implying any actual such relationship or order between such entities.

As will be described in more detail below, one particular advantage associated with the automotive vehicle maintenance and repair system described herein is that the system may create a mutually beneficial relationship between a manufacturer of an automotive data retrieving tool or a diagnostic services provider, and a retailer of automotive parts and services. In general, the manufacturer (or diagnostic service provider) provides the hardware and/or software for retrieving and analyzing vehicle diagnostic data. The retailer, on the other hand, may have already existing resources for efficiently selling the manufacturer's product. In this respect, the system may benefit the tool manufacturer because the manufacturer's tool will ultimately be sold, and the retailer will benefit since during the course of an end user using the manufacturer's hardware/software, the need for parts and services will be identified, which can be fulfilled or sold by the retailer. Another beneficiary of the system may be the end user of the automotive data retrieving tool, since the system may allow for a more streamlined and automated management of the automobile's maintenance and repair.

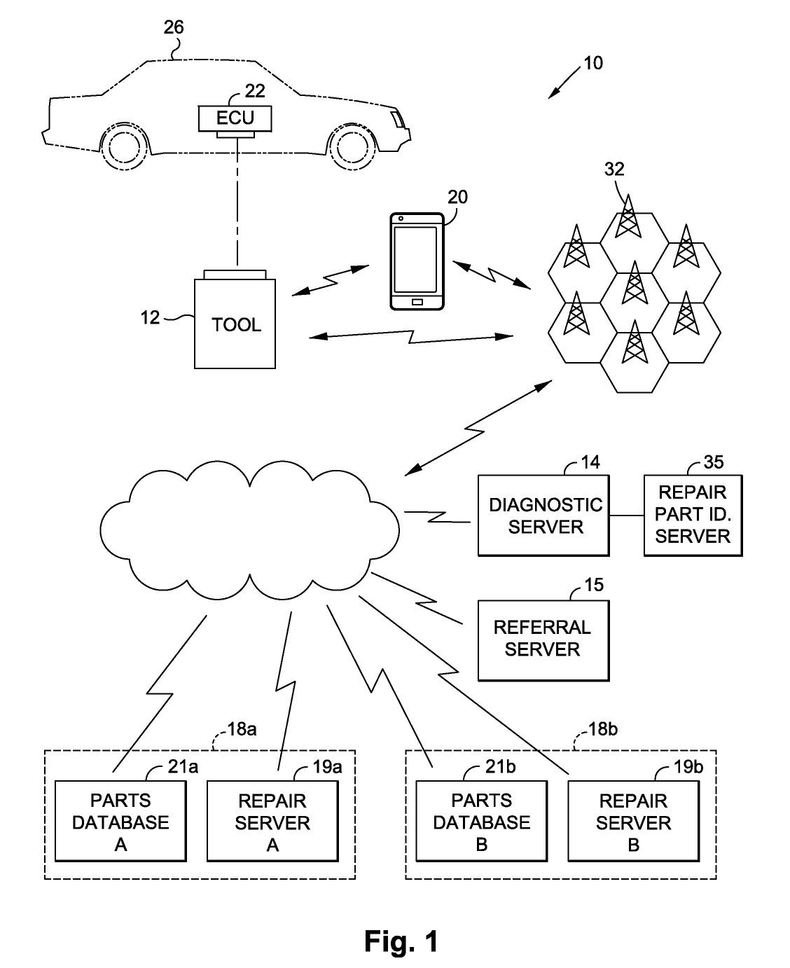

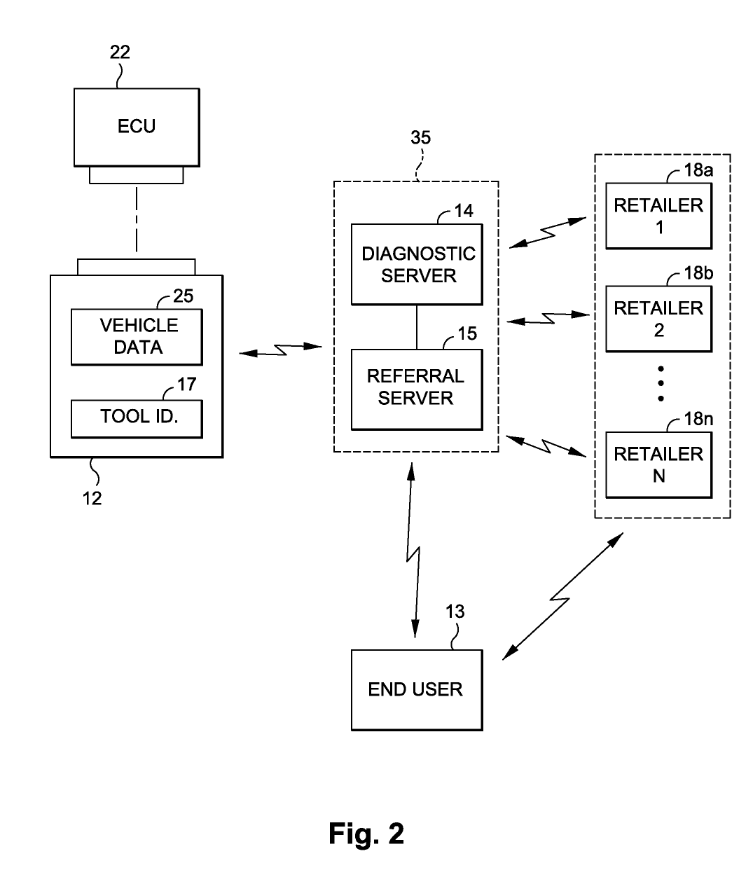

Referring now to FIGS. 1 and 2, there is depicted an exemplary embodiment of the automotive vehicle maintenance and repair system 10. The system 10 generally includes an automotive data retrieving tool 12, a diagnostic server 14, a referral server 15, and a first retailer 18a having a repair server 19a and a parts database 21a, and a second retailer 18b having a repair server 19b and a parts database 21b. The retailers 18, as well as the diagnostic and referral servers 14, 15 may be in communication with an end user 13, typically through the user's smartphone, computer, email account, etc.

As used herein, the term “data retrieving tool” refers to a hardware tool or software product downloadable onto an electronic device, which is designed to allow for communication with the vehicle's electronic control unit (ECU) 22 for retrieving vehicle data 25 therefrom. The data retrieving tool 12 includes a unique tool identifier 17, which may be used to match the tool 12 to a selling retailer 18, which may be one of several third party retailers, as will be described in more detail below. The unique tool identifier 17 may be an electronic part identification number (similar to a VIN), a serial number, product number, an alphanumeric identifier, or a digital file (e.g., a signal header) associated with the tool 12. The data retrieving tool 12 may include a scan tool, code reader, dongle, or downloadable software for a mobile device, such as a smart phone, a tablet computer, or the like.

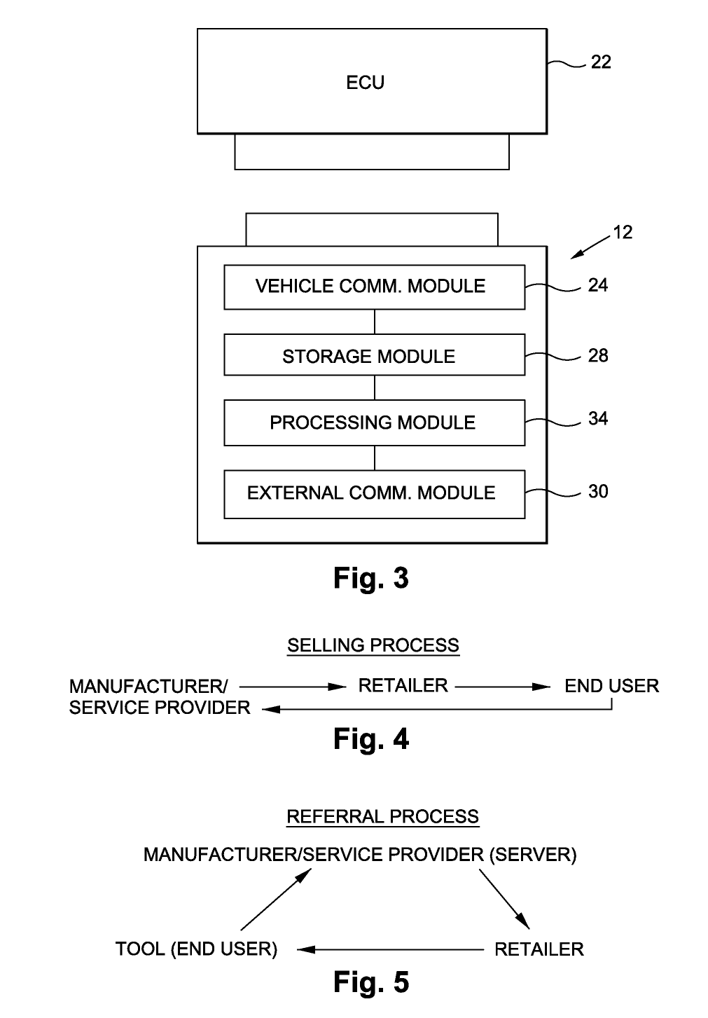

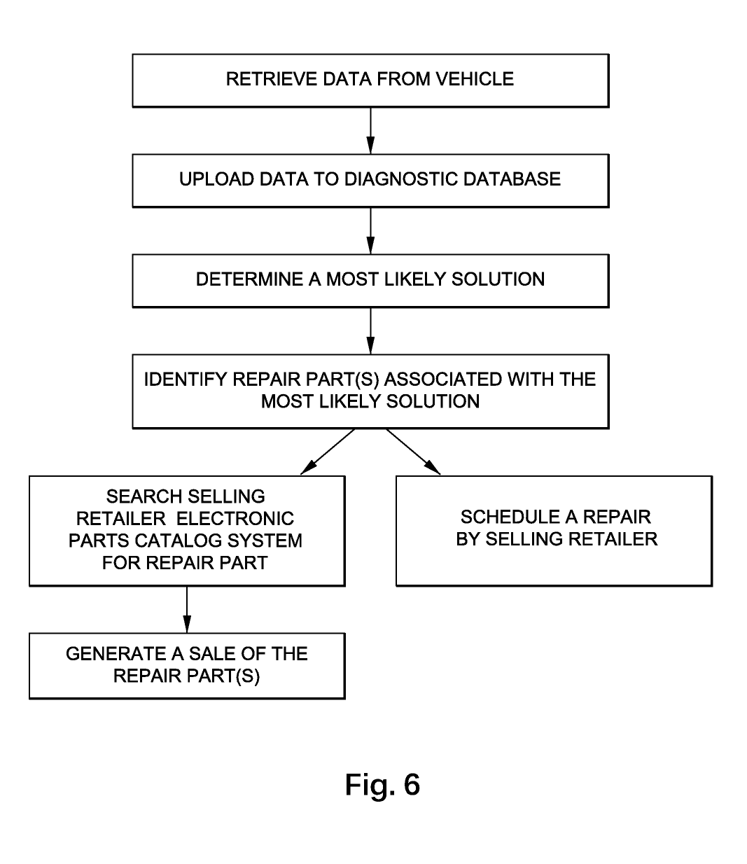

Referring now specifically to FIG. 3, the hardware typically associated with a data retrieving tool 12 includes a vehicle communications module 24 configured to interface with the vehicle's ECU 22 via wired or wireless communication for retrieving data and information 25 from the vehicle 26. In this respect, the vehicle communications module 24 may be capable of communicating in the protocol required by the vehicle's ECU 22. The information and data received from the vehicle 26 may include diagnostic trouble codes (DTCs), live data, freeze frame data, PID signals, vehicle identification information (such as the electronic vehicle identification number), etc. For wired communication, the vehicle communications module 24 may be plug connectable to the onboard diagnostic port (e.g., OBD-II port) located on the vehicle 26. For wireless communication, the vehicle communications module 24 may communicate via short range, wireless communication, such as Bluetooth™, WiFi or similar wireless communications protocols known in the art. In this respect, it is contemplated that the vehicle 26 itself may include a wireless transceiver for effectuating the wireless communication. Alternatively, a wireless transmitter may be connected to the onboard diagnostic port for wirelessly communicating information to the data retrieving tool 12.

A storage module 28 may be in communication with the vehicle communication module 24 to allow for storage of vehicle operational data and vehicle information retrieved from the ECU 22. The storage module 28 may be configured to store the data and information for short periods of time (e.g., buffering) or for more extended periods of time.

An external communication module 30 may be in communication with the storage module 28 to upload the retrieved vehicle operational data and information to a remote location. The external communication module 30 may be capable of communicating with a remote device (e.g., a smartphone 20, remote server, etc.) via wired or wireless communication. For wired communication, the external communication module 30 may be plug connectable to the remote device, such as to a USB port on a computer. For wireless communication, the external communications module 30 may be capable of short range wireless communication (e.g., Bluetooth™ or the like) to upload the vehicle operational data to a nearby electronic device, such as a smartphone 20, which may ultimately upload the vehicle operational data to a remote server. The general architecture of a tool 12 that includes hardware which interfaces with a vehicle 26 as well as a smartphone 20 for purposes of uploading vehicle operational data to a remote server via the smartphone 20 may be referred to as a “telematics” system. For more information regarding such cellphone based vehicle diagnostic systems, please refer to U.S. Pat. No. 8,068,951, entitled Vehicle Diagnostic System, the contents of which are expressly incorporated herein by reference.

The external communications module 30 may also be capable of long-range wireless communication. In this respect, the external communications module 30 may communicate over a cellular communications network 32, the Internet, or via other long-range communications systems.

The general architecture of the data retrieving tool 12 may further include a processing module 34 in communication with the communication modules 24, 30, as well as the storage module 28 to operate the data retrieving tool 12. The processing performed locally on the tool 12 may include communications processing, data format processing, as well as diagnostic processing. The diagnostic processing may include interpretation of diagnostic trouble codes (DTCs). The processing module 34 may be able to generate a “repair-needed” signal, which may be relayed to a selling retailer 18, as will be described in more detail below. The level of diagnostic processing may vary from one tool 12 to the next. For instance, a basic dongle-type tool 12 may not perform any diagnostic processing, and rely on the resources of the external diagnostic server 14 for such processing. On the other hand, a more sophisticated scan tool may perform certain diagnostic functions locally on the tool 12.

As noted above, the data retrieving tool 12 may be packaged in a wide range of embodiments which may serve a host of different end users. For instance, the data retrieving tool 12 may include a conventional scan tool which may be sold to individual car owners, as well as a fleet manager for use in managing a fleet of vehicles 26. In this respect, the vehicle operational data may provide a window through which the fleet manager may view the operation of the associated vehicles to determine the employee's driving habits, and efficiency, as well as to manage the cost of owning and operating the vehicle. For instance, the cost per mile may be calculated and the cost of owning various vehicles may be compared.

The data retrieving tool 12 may also be embodied in a dongle which may be plugged into an onboard diagnostic port of the vehicle 26 to retrieve real time information from the vehicle 26. Alternatively, the data retrieving tool 12 may include software which is downloadable onto a mobile device 20 which includes hardware for interfacing with the vehicle 26.

When the vehicle operational data is gathered by the data retrieving tool 12, the data may be useful for a wide range of purposes. In general, the data is analyzed at a diagnostic database or server for purposes of making a diagnostic assessment. For instance, the vehicle operational data may include DTCs and other diagnostic information which may be analyzed to determine possible diagnostic problems, possible diagnostic solutions, possible diagnostic repairs, possible diagnostic parts, and/or possible diagnostic repair procedures. For additional information regarding the use of DTCs and other diagnostic data, please refer to U.S. Pat. No. 8,370,018, entitled Method of Ranking Automotive Repair Solutions Associated with Automotive Diagnostic Data, the contents of which are expressly incorporated herein by reference. The vehicle operational information may also be useful for predictive purposes, such as predictive diagnostics, predictive maintenance, predictive cost(s), and predictive value of the vehicle. In this respect, current vehicle operational data may be used to predict a diagnostic condition of the vehicle in the future based on one or more factors, which may include vehicle identification information (e.g., year, make, model, engine), the driving habits of the owner (e.g., braking/acceleration habits, number of miles driven per year, geographic region of owner, climate factors, etc.). The predictive assessment may be made by comparing the received vehicle data and information with a compilation of stored data and information for similar vehicles. For more information regarding the use of vehicle operational information for purposes of predictive diagnostics, please refer to U.S. patent application Ser. No. 13/589,532, entitled Predictive Diagnostic Method, the contents of which are expressly incorporated herein by reference. For other related diagnostic methods, please refer to U.S. Pat. No. RE 40,799, entitled System & Method for Computer Network Implemented Vehicle Diagnostics, U.S. patent application Ser. No. 13/567,745, entitled Hand Held Scan Tool with Fixed Solution Capability, U.S. patent application Ser. No. 13/467,884, entitled Smart Phone App-Based Vehicle Diagnostic System and Method, and U.S. patent application Ser. No. 14/102,287 entitled Smartphone Based Telematics Application, the contents of each aforementioned reference being expressly incorporated herein by reference.

Recognizing the versatility and the wide ranging use of information retrieved from the vehicle 26, as well as information which may be derived therefrom, there are a multitude of third party entities which could benefit directly or indirectly from such information. For instance, one primary beneficiary would be a company that provides and sells automotive parts and repair services (referred to herein as a “selling retailer” 18). Exemplary selling retailers 18 include AutoZone™ and NAPA™, as well as car dealerships. Selling retailers 18, particularly nationwide companies, have existing infrastructures for easily selling data retrieving tools 12. In particular, such selling retailers 18 have resources, such as large sales teams with existing relationships with end users, i.e., individuals or fleet managers.

Therefore, various aspects of the present invention are directed towards creating a partnership between the manufacturer/diagnostic service provider of the data retrieving tool 12 and the selling retailers 18 for the purposes of selling the data retrieving tool 12 and creating referrals back to the selling retailer 18 during use of the tool 12 by the end user. FIG. 4 illustrates a process for manufacturing and selling the tool 12, whereas FIG. 5 shows a relationship for generating referrals for the retailer 18 during use of the tool 12. In FIG. 4, the manufacturer/service provider provides the retailer 18 with the tool 12, with the retailer ultimately selling the tool 12 to the end user. After the tool 12 is sold to the end user, the end user may register the tool 12 and create an account with the diagnostic provider 35 (e.g., the diagnostic and referral servers 14, 15), as well as the selling retailer 18. The registration process may allow the diagnostic provider to correlate the unique tool identifier 17. In this respect the end user 13 may identify where the tool 12 was purchased by entering the retailer's name or selecting the retailer from a list. It is also contemplated that the diagnostic provider may correlate the unique tool identifier 17 with the selling retailer prior to the tool 12 being sold. For instance, the association between the unique tool identifier 17 and the selling retailer 18 may be made at the time the tool 12 is shipped to the selling retailer. The registration process additionally allows the diagnostic provider to correlate the unique tool identifier with the end user 13, and more specifically, with the end user's contact information, which may include a phone number, mailing address, e-mail address, twitter account, or other social media account. The registration process may entail the end user 17 creating an account with the diagnostic provider, wherein the diagnostic provider may include an intern communications system (e.g., an internal e-mail account) for communicating with the end user 17. Furthermore, the registration process may require the end user 17 to consent to the sharing of data and information with the selling retailer, including the sharing of vehicle data 25, tool identifier 17, end user contact information, diagnostic assessments, required parts and/or services, etc. The registration process may further allow the end user 17 to select a preference for future communications as well as make default settings. For instance, the user 17 may choose to have any replacement part automatically shipped to a specified address, or have any service automatically scheduled during pre-defined availability times (e.g., certain times or days of the week).

The association between the unique tool identifier 17 and the selling retailer 18 allows the system 10 to determine which selling retailer 18 should receive any related referral signal when a diagnostic assessment is made. It is contemplated that a correlation or relationship is established between the tool 12 and a particular one of several third party retailers 18a, 18b, 18n in order to classify that retailer as the “selling retailer.” The relationship between the tool 12 and the selling retailer 18 may be created by assigning a product number or identifier 17 with data retrieving tools 12 sold by that particular retailer 18. For instance, the system 10 may be set up such that all tools 10 having a product number ending in -10- are associated with a first selling retailer 18a, while all tools having a product number ending in -15- are associated with a second selling retailer 18b. In this respect, when data is analyzed for purposes of making a diagnostic assessment, the unique identifier associated with the corresponding tool 12 may be uploaded with the operational data to allow the system to identify the particular selling retailer associated with the data.

According to another embodiment, the data retrieving tools 12 may be associated with a prescribed selling retailer 18 when the tools 12 are shipped to the selling retailer 18. In particular, each data retrieving tool 12 may include a serial number or barcode which can be read or scanned as the tools 12 leave the manufacturing warehouse for shipment to the retailer 18. In this respect, the serial number or barcode associated with those data retrieving tools 12 may be correlated or assigned to the selling retailer 18 as they leave the warehouse. As such, any subsequent activity or referrals generated by the use of those data retrieving tools 12 may be referred back to the corresponding selling retailer 18.

In use, the tool 12 receives data and information from a vehicle 26 for analysis. The analysis may be conducted locally on the tool 12, or uploaded to the diagnostic server 14 either directly from the tool 12 or via the computing device 20, such as a mobile device, computer, etc. When the diagnostic database 14 determines that a repair is needed, a repair signal is generated and the system 10 communicates the repair signal to the referral server 15, which determines which retailer is the particular selling retailer 18 associated with the particular tool 12. Once the particular selling retailer 18 is identified, the referral server 15 generates a referral signal which may include the diagnostic data and information, as well as the diagnostic assessment, including a possible repair part or repair service associated with the diagnostic assessment. The referral server 15 may also send the diagnostic assessment to the end user 13 via the desired communication method selected during the registration process. It is also contemplated that the diagnostic database 14 may communicate the diagnosis back to the tool 12 (either directly or via the computing device 20) or to the manufacturer.

When the retailer 18 becomes aware of the diagnosis (e.g., receives the referral signal), the repair server 19 may coordinate a commercial transaction based on the diagnostic assessment. Along these lines, the repair server 19 may send a communication to the end user, with the communication being sent either to the tool 12, to the computing device 20 or via other communications requested by the end user (i.e., email, phone call, SMS message, etc.). In this respect, the end user can quickly and easily address the problem with the vehicle 26. In some instances, the system 10 may operate autonomously, such that the end user may authorize the retailer 18 to send any parts or schedule any service that the system 10 determines is needed.

As noted above, various aspects of the invention require that there is a “selling retailer” 18 associated with the tool 12. In most instances, the selling retailer 18 is the particular retailer that sold the tool 12 to the end user, although that is not necessary. The selling retailer is the particular retailer to which the referral signal is communicated. In this respect, the selling retailer 18 may be a third party parts store or service garage which has a relationship with the company that actually sold the tool 12. In this respect, the third party parts store and service garage will receive the future referrals and the original seller of the tool 12 may receive a royalty or payment for the future referrals.

It is also understood that the selling retailer 18 may be a car dealership which can benefit from having referrals back to the car dealership when the need for repair parts and services arise. Furthermore, the car dealership may also benefit from knowing the usage of the vehicle associated with the data retrieving tool 12 for purposes of reselling a vehicle 26. For instance, the car dealership may offer to buy a vehicle 26 which fits certain parameters in order to fulfill an existing need in the market. Furthermore, the predictive diagnostics referred to herein may be a powerful aid in setting a selling price for a vehicle 26. For more information, please refer to U.S. patent application Ser. No. 13/569,522, entitled Smart Phone App-Based Method and System of Collecting Information for Purchasing Used Cars, the contents of which are expressly incorporated herein by reference.

The selling retailer may also be a car insurance company which may benefit from monitoring the driving habits of the end user. In this respect the price of the insurance premium may be adjusted based on the driving habits detected by the data retrieving tool.

In this regard, it is understood that the manufacturer of the diagnostic tool 12 may create a partnership with a wide-range of companies who can benefit from the information retrieved from the vehicle 26, as well as information derived therefrom.

The foregoing system 10 describes a implementation when a diagnostic assessment is made which requires the purchase of a repair part. According to one embodiment, when the diagnostic assessment involves a repair part, the diagnostic assessment is communicated to a repair parts identification server 35, which includes repair parts organized according to the diagnostic assessment and vehicle identification information (which may be retrieved by the tool 12). The repair part may also be matched with a universal part identification number. An example of a universal parts identification system is the Aftermarket Catalog Enhanced Standard (ACES) parts numbering system, although other universally accepted parts identification systems may also be used in connection with the present invention without departing from the spirit and scope of the present invention.

The repair part identified by the diagnostic server 14 may be matched with the parts listed in the repair parts identification database 35 to determine the universal part number associated with the repair part. It is understood that a given part (e.g., a mass airflow sensor) may vary from one vehicle to the next. Accordingly, there may be several universal part identification numbers associated with the different mass airflow sensors. As such, in order to identify a specific mass airflow sensor that is adapted for use with a specific vehicle, vehicle identification information is required. Thus, the repair parts identification database may receive that vehicle identification information as part of the upload from the tool 12. Alternatively, the repair parts identification database may receive a universal vehicle identification number from a vehicle identification unit, as will be explained in more detail below.

It is also contemplated that in addition to parts being assigned universal identification numbers, vehicles may also be assigned a universal vehicle identification number, which corresponds to vehicles having the same year, make, model, and engine type. Thus, once a vehicle 26 has been identified, the specific parts used on that vehicle 26 may also be identified. Consequently, each universal vehicle identification number will be associated with various universal part identification numbers. When the vehicle 26 under consideration has been identified, the universal part numbers associated with the vehicle 26 may be focused on to simplify the analysis.

The diagnostic methods described herein may be useful in various e-commerce applications, as illustrated in the flow chart depicted in FIG. 5. For instance, when the system 10 identifies a most likely defect and/or a repair part or procedure associated with the most likely defect, the system 10 may take steps to quickly effectuate the repair. One particular aspect of the system 10 is that certain steps in the overall process may proceed automatically, without any input from the user, thereby reducing the burden on the user.

According to one embodiment, the system 10 may automatically complete the sale of the repair part to expedite the repair if certain conditions are met. For instance, the user may only want to purchase the part if the associated most likely defect is critical. Conversely, if the part is associated with a non-critical defect, the user may be prompted for authorization to complete the sale of the part.

The process of completing the sale of the repair part may include establishing a link between the diagnostic server 14 and an electronically searchable parts catalog or database 21 to determine if the selling retailer 18 carries the specific repair part needed (e.g., the repair part associated with the specific part number), if the repair part is in stock, as well as determining the price of the repair part. The search of the parts database 21 may be completed automatically without any input from the user. The repair server 19 may be in communication with the repair parts identification database 35 and an electronic catalogue 21 for effectuating the sale.

The system 10 may be configured to automatically ship the part to the user to allow the user to complete the repair. Alternatively, the part may be set aside for the user at the selling retailer 18 for pickup. In other embodiments, the sale of the part may not be completed until the user arrives at the store. The user may be sent part tracking information to enable quick and easy completion of the sale once the user arrives at the store. For instance, the system 10 may send an email and/or text message to the user with a reference number, tracking number, bar code, or other transaction identification information to simplify the sale when the user arrives at the store. The part information may also be displayed for the customer at the selling retailer 18 to allow the customer to visually confirm the information prior to purchase.

In addition to automatically generating a sale of the part, the system 10 may also automatically schedule a repair to install the new repair part. The automatic scheduling of the repair may be particularly useful in fleet management applications. When a repair is automatically scheduled, the user/fleet manager may be sent a message with details associated with the repair, such as the date/time of the repair, estimate time to complete the repair, cost of the parts/service, etc.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. An automotive diagnostic method for use with an automotive data retrieving tool having a unique tool identifier, the automotive data retrieving tool being configured to retrieve data from a vehicle onboard computer, the unique tool identifier being associated with a selling retailer and contact information of an end user of the tool, the method comprising the steps of:
receiving, at a diagnostic server, vehicle data and the unique tool identifier from an automotive data retrieving tool having a unique;
analyzing the received vehicle data at the diagnostic server to make a diagnostic assessment; and
sending a referral signal to the selling retailer associated with the automotive data retrieving tool based on the received unique tool identifier, the referral signal including the diagnostic assessment and the contact information of the end user of the tool.

2. The automotive diagnostic method recited in claim 1, wherein the referral signal includes information regarding a replacement part associated with the diagnostic assessment and offered for sale by the selling retailer.

3. The automotive diagnostic method recited in claim 1, wherein the referral signal includes information regarding a repair service associated with the diagnostic assessment and offered for sale by the selling retailer.

4. The automotive diagnostic method recited in claim 1, further comprising the step associating the selling retailer with the unique tool identifier after the selling retailer sells the automotive data retrieving tool to the end user.

5. The automotive diagnostic method recited in claim 1, further comprising the step of associating the selling retailer with the unique tool identifier before the selling retailer sells the automotive data retrieving tool to the end user.

6. The automotive diagnostic method recited in claim 1, further comprising the step of communicating a diagnostic signal including the diagnostic assessment to the end user.

7. The automotive diagnostic method recited in claim 1, wherein the diagnostic assessment is associated with a repair part, the method further comprising the step of:
searching an electronic parts database associated with the selling retailer for the repair part.

8. The automotive diagnostic method recited in claim 7, wherein the repair part is associated with a universal part number associated with vehicle identification information, the method further including the step of receiving vehicle identification information.

9. The automotive diagnostic method recited in claim 8, wherein the universal part number is an Aftermarket Catalog Enhanced Standard (ACES) part number.

10. The automotive diagnostic method recited in claim 1, wherein the diagnostic assessment includes a predictive assessment of future diagnostic conditions.

11. The automotive diagnostic method recited in claim 1, further comprising the step of providing the automotive data retrieving tool to the selling retailer.

12. An automotive diagnostic system comprising:
a diagnostic and referral server in communication with an automotive data retrieving tool configured to retrieve data from an onboard vehicle computer, the automotive data retrieving tool having a unique tool identifier being associated with a selling retailer and an end user contact information, the diagnostic and referral server being configured to receive the retrieved data from the automotive data retrieving tool and analyze the retrieved data to make a diagnostic assessment and to send a referral signal to the selling retailer, the referral signal including information related to the diagnostic assessment and the end user contact information.

13. The automotive diagnostic system recited in claim 12, wherein the referral signal includes information for purchasing a repair part associated with the diagnostic assessment.

14. The automotive diagnostic system recited in claim 12, wherein the referral signal includes information for scheduling a repair service associated with the diagnostic assessment.

15. The automotive diagnostic system recited in claim 12, wherein the diagnostic assessment is associated with a repair part, the system further comprising:
an electronic parts database associated with the prescribed selling retailer.

16. The automotive diagnostic system recited in claim 15, wherein the repair part is associated with a universal part number associated with vehicle identification information, the electronic parts database having repair parts associated with corresponding universal part numbers.

17. The automotive diagnostic system recited in claim 17, wherein the universal part number is an Aftermarket Catalog Enhanced Standard (ACES) part number.

18. The automotive diagnostic system recited in claim 12, wherein the diagnostic and referral server is configured to conduct a predictive assessment of future diagnostic conditions based on the retrieved data.

19. A method of associating a third party retailer with an automotive data retrieval tool configured to retrieve diagnostic data from an onboard vehicle computer and being associated with a unique tool identifier and end user contact information the method comprising the steps of:
receiving information associating a first one of a plurality of retailers with the unique tool identifier;
receiving diagnostic data from the automotive data retrieval tool;
analyzing the diagnostic data to determine a diagnostic assessment; and
communicating a referral signal to the first one of the plurality of retailers, the referral signal including the diagnostic assessment and the end user contact information.

20. The automotive diagnostic method recited in claim 19, wherein the referral signal includes information regarding a replacement part associated with the diagnostic assessment and offered for sale by the selling retailer.

21. The automotive diagnostic method recited in claim 19, wherein the referral signal includes information regarding a repair service associated with the diagnostic assessment and offered for sale by the selling retailer.

22. The automotive diagnostic method recited in claim 19, further comprising the step of providing the automotive data retrieval tool for sale to the plurality of third party retailers.
